(19) United States
(12) Patent Application Publication
(10) Pub. No.: US 2026/0093290 A1
(43) Pub. Date: Apr. 2, 2026

(54) Hinged Device

(71) Applicant: Microsoft Technology Licensing, LLC, Redmond, WA (US)

(72) Inventors: Tung Yuen LAU, Hong Kong (CN); Denys V. YAREMENKO, Carnation, WA (US); Jingjiang ZHANG, Hangzhou (CN); Zike HU, Hangzhou (CN); Daniel C. PARK, Woodinville, WA (US); Eric WITT, Redmond, WA (US); Devin CAPLOW-MUNRO, Seattle, WA (US); Brett A TOMKY, Seattle, WA (US)

(73) Assignee: Microsoft Technology Licensing, LLC, Redmond, WA (US)

(21) Appl. No.: 19/112,222

(22) PCT Filed: Oct. 18, 2022
(86) PCT No.: PCT/CN2022/125873

§ 371 Date: Mar. 14, 2025

(51) Int. Cl. G06F 1/16; H04M 1/02

(52) U.S. Cl. CPC G06F 1/1681; H04M 1/022

(57) ABSTRACT

The description relates to hinged devices, such as hinged computing devices. One example can include a first portion secured to a first hinge arm that is configured to rotate around a first hinge axis and a second portion secured to a second hinge arm that is configured to rotate around a second hinge axis. A timing shuttle can be positioned on a central shaft that is located between the first hinge axis and the second hinge axis and is configured to control a frictional torque experienced by the first and second hinge arms depending upon orientation of the first and second hinge arms and to synchronize rotation of the first and second hinge arms around the first and second hinge axes.

### BACKGROUND

Many computer form factors such as smart phones, tablets, and notebook computers can provide enhanced functionality by folding for storage and opening for use. For instance, the folded device is easier to carry and the opened device offers more input/output area.

### SUMMARY

This patent relates to hinged devices, such as hinged computing devices. One example can include a first portion secured to a first hinge arm that is configured to rotate around a first hinge axis and a second portion secured to a second hinge arm that is configured to rotate around a second hinge axis. A timing shuttle can be positioned on a central shaft that is located between the first hinge axis and the second hinge axis and is configured to control a frictional torque experienced by the first and second hinge arms depending upon orientation of the first and second hinge arms and to synchronize rotation of the first and second hinge arms around the first and second hinge axes.

This example is intended to provide a summary of some of the described concepts and is not intended to be inclusive or limiting.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced. Where space permits, elements and their associated reference numbers are both shown on the drawing page for the reader's convenience. Otherwise, only the reference numbers are shown.

FIGS. 1A-1C, 2A, 3A, 4A, 6A, 7A, 8A, 9A, 10A, and 11A show perspective views of example devices in accordance with some implementations of the present concepts.

FIG. 2B shows an exploded perspective view of the example device of FIG. 2A in accordance with some implementations of the present concepts.

FIGS. 2C, 3B, 4B, 5, 6B, 7B, 8B, 9B, 10B, and 11B show elevational views of example devices in accordance with some implementations of the present concepts.

FIG. 2D shows an exploded elevational view of the example device of FIG. 2C in accordance with some implementations of the present concepts.

### DESCRIPTION

The present concepts relate to devices, such as computing devices employing hinge assemblies that can allow rotation of first and second device portions through a range of orientations (e.g., relative angles). Some implementations can employ a central controller that is located on a central shaft between hinge axes defined by the hinge assembly. These implementations provide a technical solution in that the controller can control friction relating to resistance to rotation (e.g., frictional torque) of the first and second portions, can synchronize rotation of the first and second portions, and can cause pop-up energy to be stored at some orientations. The pop-up energy can be released to automatically open the device from a closed orientation. These and other aspects are described below by way of example.

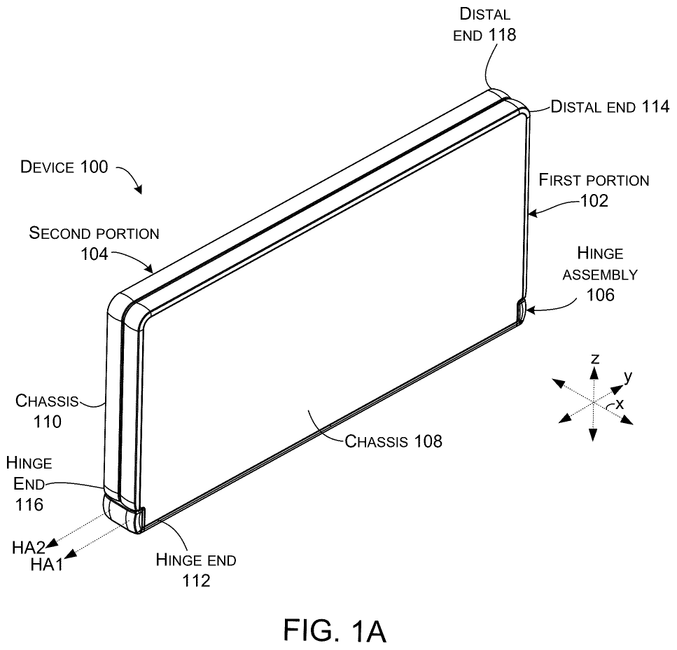

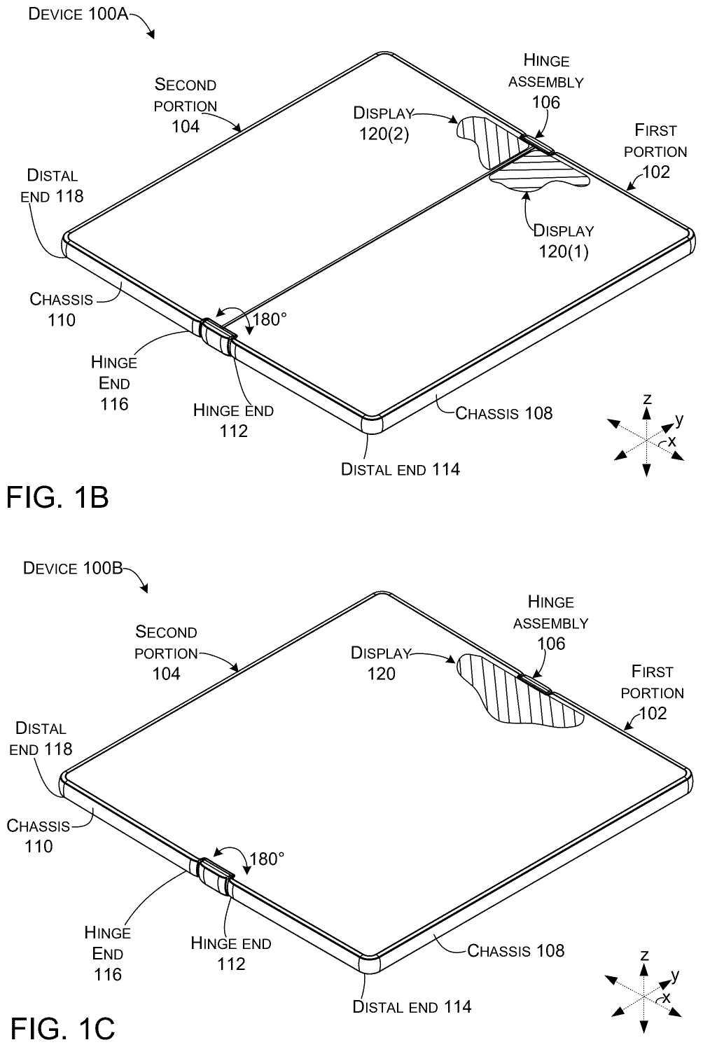

Introductory FIGS. 1A-1C collectively show two example device configurations. The device 100 includes first and second portions 102 and 104 that are coupled by a hinge assembly 106 to allow rotation through a range of orientations (e.g., relative angles). The first portion 102 includes a housing or chassis 108 and the second portion 104 includes a housing or chassis 110. The first portion 102 extends from a hinge end 112 to a distal end 114 and the second portion 104 extends from a hinge end 116 to a distal end 118. The hinge assembly 106 defines hinge axes (HA).

FIG. 1A shows a device 100 in a closed or approximately zero-degree orientation. As used herein the approximately zero-degree orientation can be exactly zero degrees and can also include orientations within+/−about three degrees (e.g., −3 degrees to +3 degrees). FIG. 1B shows a first variation of device 100A in an open orientation of about 180 degrees and FIG. 1C shows a second device variation of device 100B in an open orientation of about 180 degrees. As used herein the approximately 180-degree orientation can be exactly 180 degrees and can also include approximate orientations within+/−about five degrees (e.g., 175-185 degrees).

FIG. 1B shows example device 100A with a first display 120(1) positioned on the chassis 108 of the first portion 102 and a separate and distinct second display 120(2) positioned on the chassis 110 of the second portion 104. The displays 120(1) and 120(2) abut at the hinge assembly 106 in the 180-degree orientation.

FIG. 1C shows example device 100B with a single display 120 spanning from the first portion 102 over the hinge assembly 106 to the second portion 104. The single display 120 can be a flexible display that can bend at the hinge assembly 106B when the device is closed. The hinge assembly 106B can provide space for an enlarged minimum bend radius for the display 120 (e.g., teardrop shape) over the hinge assembly 106 as the device 100 is closed to reduce potential damage, such as crimping of the flexible display. In both of the illustrated configurations of FIGS. 1B and 1C, portions of the hinge assembly 106 are visible at the edges of the device. In other implementations, the hinge assembly 106 may not be readily visible.

The hinge assemblies 106 can satisfy various design parameters by providing technical solutions, such as providing relatively high friction (e.g., frictional resistance to rotation or frictional torque) at some orientations to maintain the device portions in a given orientation. For instance, if the user places the device in a 100-degree orientation, the friction (e.g., rotational torque) provided by the hinge assembly can maintain that orientation until the user changes it. The hinge assembly may also produce relatively less friction at some other orientations, such as a closed orientation, to facilitate ease of opening. The hinge assembly can also store energy as the device is closed and release this energy when the device is opened to automatically open the device a few degrees so the user can grasp both portions. For instance, the device may include a lock that automatically engages when the device is closed. When the user releases the lock, the stored energy may automatically pop the device open a few degrees, such as from zero degrees to 10 degrees. The hinge assemblies can also synchronize rotation of the first and second portions so that rotation of one portion produces simultaneous and equal rotation of the other portion. The present concepts can achieve these technical solutions on a device that is relatively thin in the z reference direction.

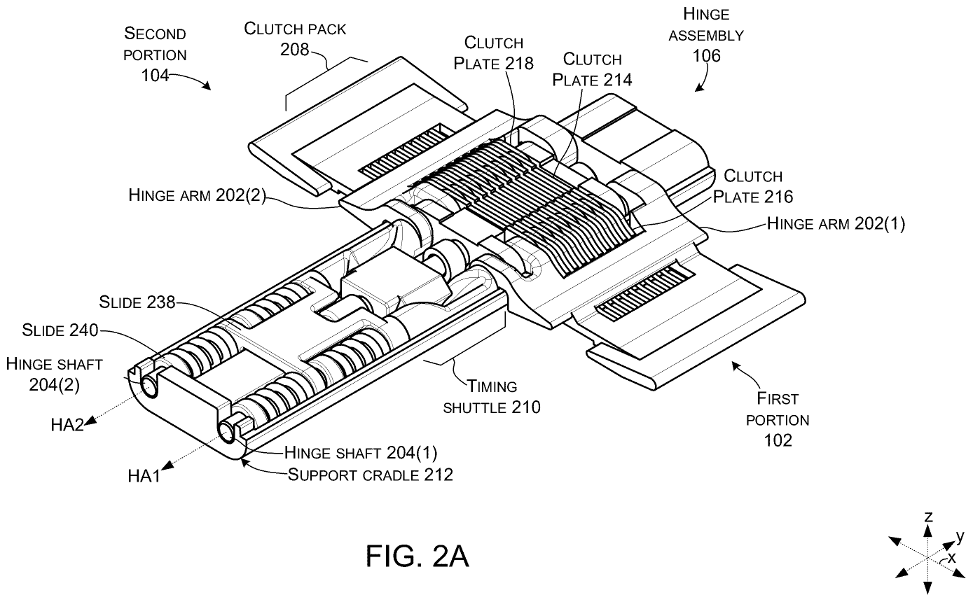

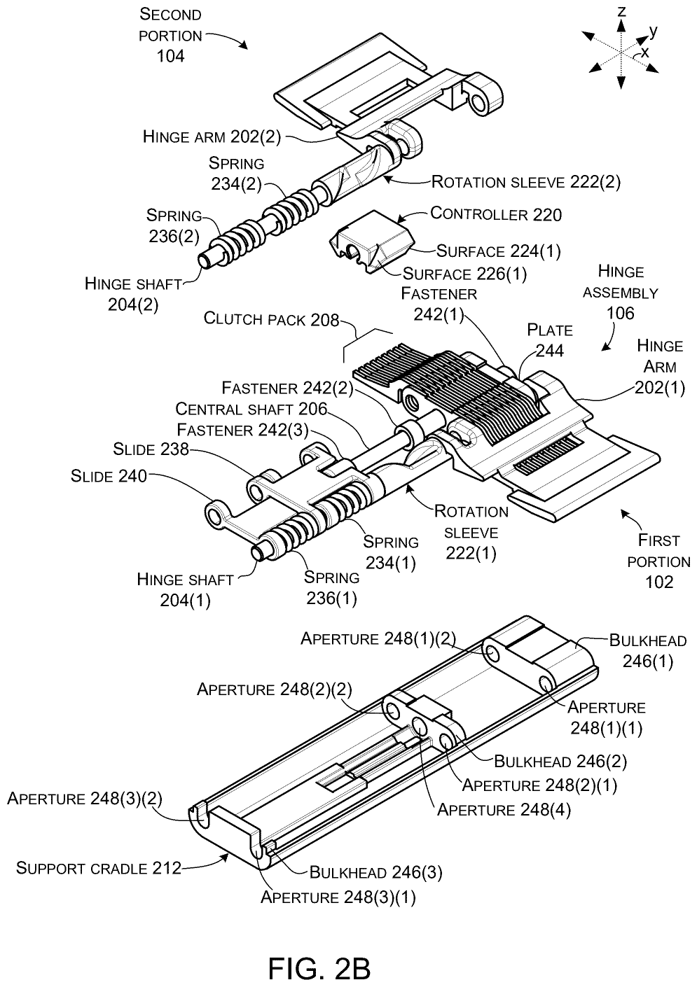

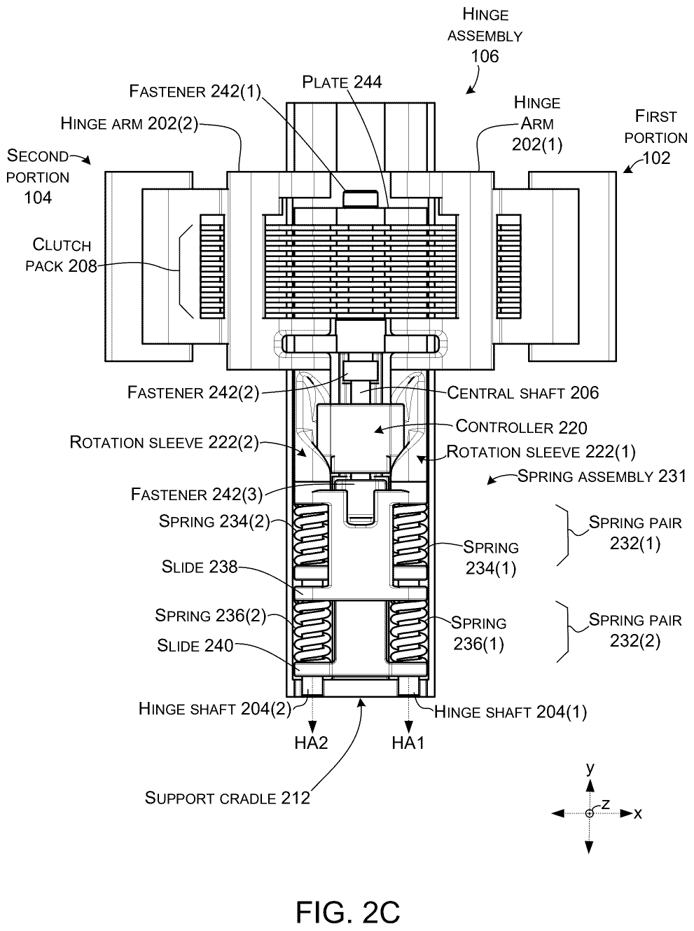

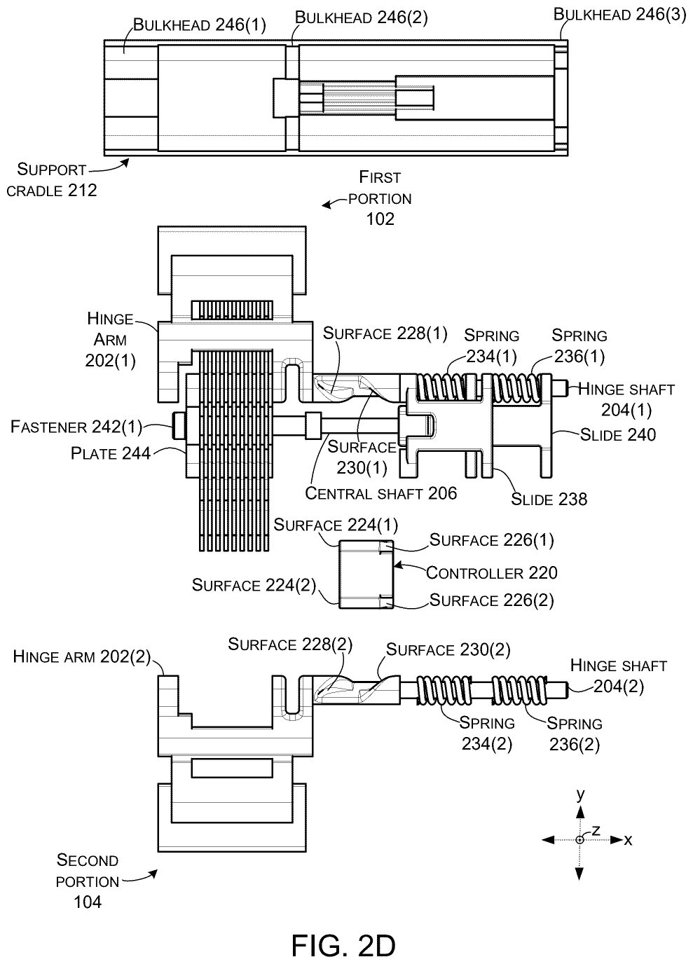

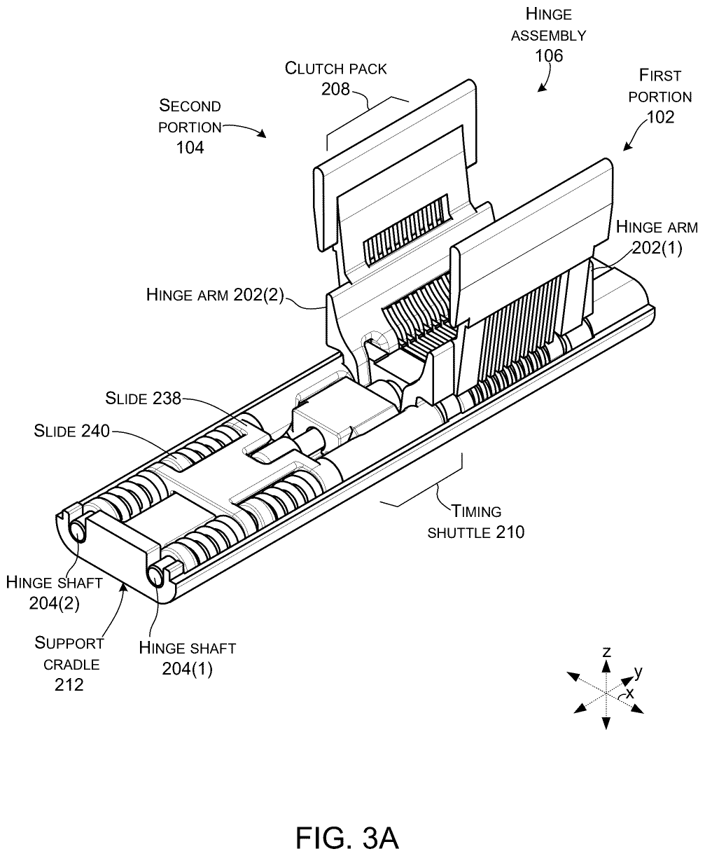

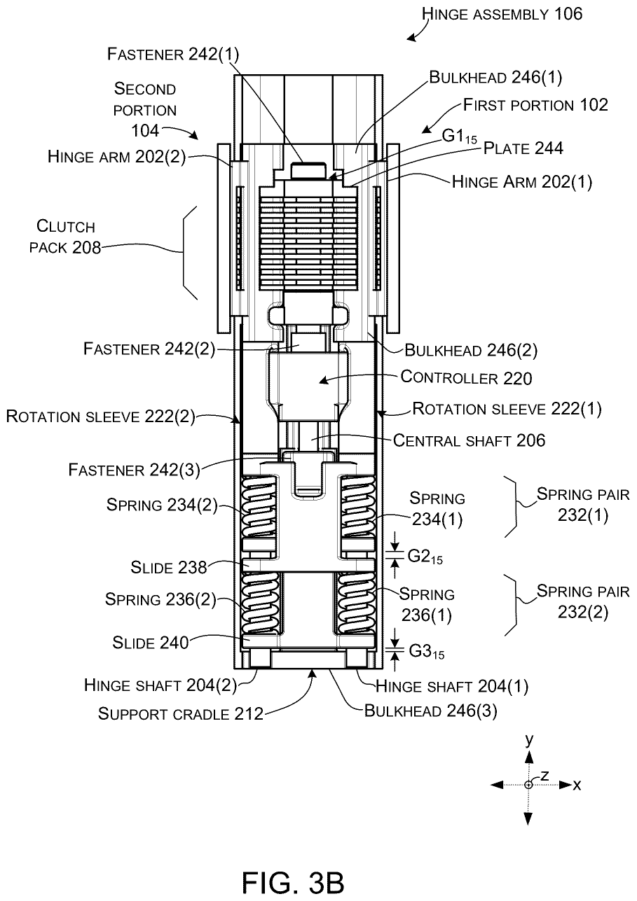

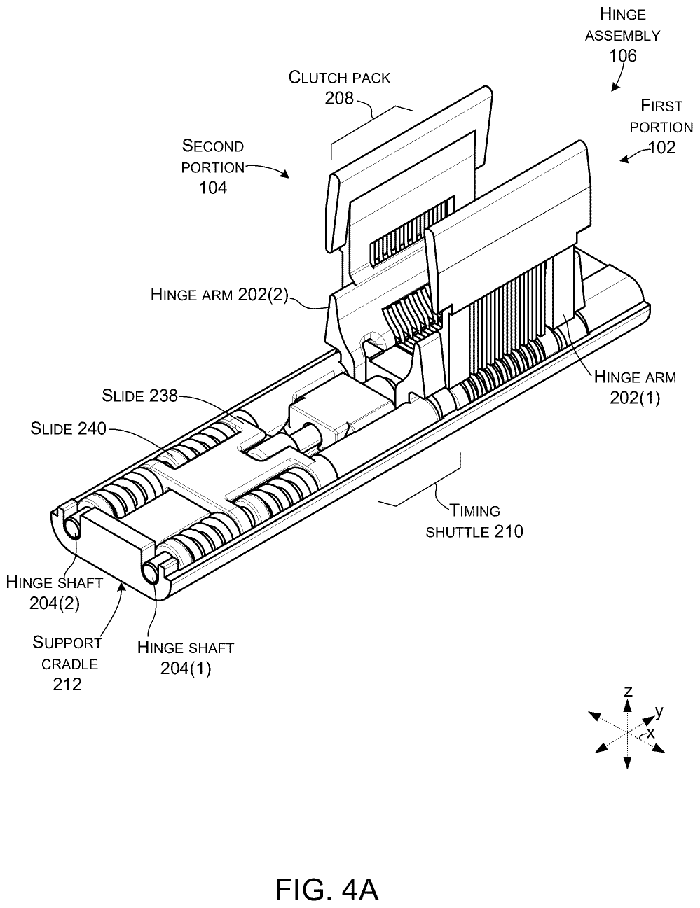

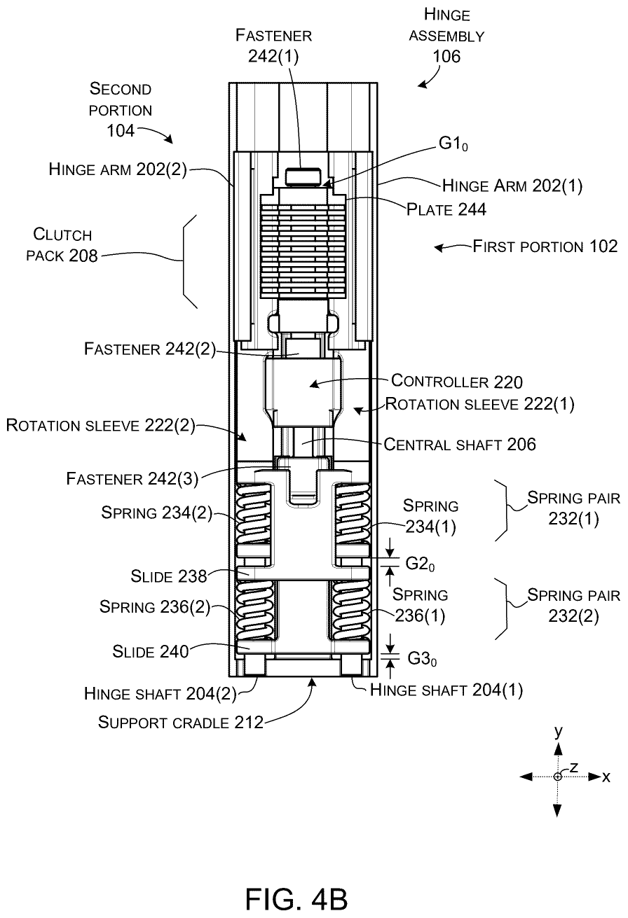

FIGS. 2A-2D, 3A-3B, and 4A-4B collectively show details of an example hinge assembly 106. FIGS. 2A-2D show the hinge assembly in a 180-degree orientation, FIGS. 3A and 3B show the hinge assembly in a 15-degree orientation, and FIGS. 4A and 4B show the hinge assembly in a closed or zero-degree orientation. FIG. 2A is a perspective view and FIG. 2B is a corresponding exploded perspective view. FIG. 2C is an elevational view and FIG. 2D is a corresponding exploded elevational view. Note that in this implementation, the range of orientations of the hinge assembly is 0 degrees to 180 degrees. Other implementations can have smaller or larger ranges. For instance, the hinge assembly could be configured to rotate from 0 to 100 degrees or 0 to 360 degrees, among other configurations.

In this case, the hinge assembly 106 includes hinge arms 202, hinge shafts 204, a central shaft 206, a clutch pack 208, a timing shuttle 210 (FIG. 2A), and a support cradle 212. (Not all elements are designated in each figure, but the elements listed in this paragraph are designated at least in FIG. 2B unless noted otherwise). The clutch pack 208 can include central clutch plates 214 (FIG. 2A) that are arranged with first side clutch plates 216 (FIG. 2A) and second side clutch plates 218 (FIG. 2A). (Only representative clutch plates are labelled to avoid clutter on the drawing page). The timing shuttle 210 can include controller 220 and rotation sleeves 222. The controller 220 can define surfaces 224 and 226 and rotation sleeves 222 can define contact surfaces 228 and 230 (FIG. 2D). This hinge assembly 106 can also include a spring assembly 231 in the form of first and second spring pairs 232 (FIG. 2C) that entail springs 234 and 236 and slides 238 and 240, fasteners 242 and plates 244. The support cradle 212 can define bulkheads 246 that define apertures 248.

The hinge shafts 204 are coextensive with hinge axes (HA) of the hinge assembly 106. The hinge arms 202 are positioned on the hinge shafts 204. The hinge arms 202(1) and 202(2) are also secured to the first and second portions 102 and 104, respectively. In some cases, the hinge arms 202 are fixedly secured to the first and second portions. In other cases, the hinge arms 202 can be moveably secured to the first and second portions. As used here, ‘moveably secured’ means that limited linear movement (e.g., sliding or translation) and/or limited rotational movement (e.g., pivoting) can occur between the hinge arms and the first and second portions. In this latter configuration, the motion of the first and second portions is driven or determined by the hinge arm rotation around the hinge axes.

The clutch pack 208 spans across the hinge arms 202 and the central shaft 206. The hinge shafts 204 can be coextensive with hinge axes (HA) defined by the hinge assembly 106. Hinge arm 202(1) is secured to the first portion 102 (indicated generally, shown with specificity in FIGS. 1A-1C) and hinge arm 202(2) is secured to the second portion 104 (indicated generally, shown with specificity in FIGS. 1A-1C). Hinge arm 202(1) is positioned in non-rotating relation with rotation sleeve 222(1) and hinge arm 202(2) is positioned in non-rotating relation with rotation sleeve 222(2). The clutch pack 208 provides a technical solution that entails a variable friction engine. The amount of rotational friction (e.g., frictional torque) produced by the clutch pack relates to how much force is applied to squeeze the clutch plates together (e.g., more squeezing force results in the clutch pack generating more frictional torque).

The clutch pack 208 is captured along the central shaft 206 between plate 244 and bulkhead 246(2). The plate 244 is retained on the central shaft 206 by fastener 242(1). In some implementations, individual fasteners 242 can be manifest as a nut that is threaded and is positioned on a threaded region of the central shaft 206 to allow adjustability in the y reference direction (e.g., parallel to the hinge axes). In other cases, individual fasteners 242 can entail a collar that is positioned at a desired location along the central shaft 206 and welded or otherwise locked in place.

The controller 220 is positioned on the central shaft 206. The rotation sleeves 222 are positioned on the hinge axes HA1 and HA2 (e.g., on the hinge shafts 204). Interaction of the controller's surfaces 224 and 226 with the contact surfaces 228 and 230 of the rotation sleeves substantially synchronizes rotation of the first and second portions 102 and 104. Thus, for example, 40 degrees of rotation of the first portion produces 40 degrees of simultaneous rotation of the second portion (+/−up to 20 degrees due to component tolerances). In this case, the contact surfaces 228 and 230 of the rotation sleeves 222 are curved surfaces. The controller 220 follows the curved contact surfaces 228 and 230 as it moves along the central shaft 206 responsive to rotation of either the first and/or second portions. In this example, the surfaces 228 and 230 are curved with a constant pitch around the hinge axes in the form of helical contact surfaces (e.g., the contact surfaces are helically curved).

Thus, the position of the controller 220 along the central shaft 206 is determined by the interaction of the controller with the rotation sleeves 222. In turn, the position of the rotation sleeves 222 is determined by the orientation of the hinge arms 202. Thus, the curved contact surfaces 228 and 230 provide a technical solution of moving the controller 220 along the central shaft 206 corresponding to rotation of the first and/or second portions by an amount (e.g., linear distance) determined by the pitch of the curved contact surfaces 228 and 230 and the extent of the rotation.

In this implementation, slides 238 and 240 overlap with one another and slide 240 extends under slide 238 and is secured relative to fastener 242(3) and indirectly to controller 220. The slides 238 and 240 and springs 234 and 236 are positioned on hinge shafts 204. The springs 234 and 236 are captured between the overlapping portions of the slides 238 and 240. The hinge shafts 204 are positioned in apertures 248. The controller 220 is positioned on the central shaft 206. The controller 220 is positioned between fastener 242(2) and fastener 242(3) on the central shaft 206. Fastener 242(3) is associated with slide 238 which also supports the central shaft 206. As noted above, the controller position is determined by the rotation angle of the hinge shafts. The controller in turn bears against fastener 242(2) near zero degrees, which then releases the spring load from the clutch pack 208 via the central shaft 206.

This example hinge assembly 106 functions as a friction hinge that creates resistance to rotation (e.g., frictional torque) that can keep the first and second portions at an orientation set by the user. In this case, the amount of friction provided by the hinge assembly is related to the orientation of the device (e.g., at some orientations the hinge assembly provides a relatively high amount of friction (e.g., resistance to rotation or ‘frictional torque’) and at other orientations the hinge assembly provides a relatively low amount friction (e.g., resistance to rotation or ‘frictional torque’)). The 180-degree orientation of FIGS. 2A-2D represents a relatively high friction orientation. The zero-degree of FIGS. 4A and 4B represents a relatively low friction orientation. The 15-degree orientation of FIGS. 3A and 3B represents a transition between the relatively low friction state of 0 degrees to 15 degrees and the relatively high friction state of 15 degrees to 180 degrees. Other implementations can employ different transition orientations, such as 10 degrees or 20 degrees, for example.

Looking at the relatively high friction orientation of FIGS. 2A-2D, first and second spring pairs 232 are biasing slide 240 away from the clutch pack 208 in the −y reference direction (e.g., toward the bottom of the drawing page). In turn, slide 240 is secured relative to fastener 242(2) and thus is biasing fastener 242(3) away from the clutch pack 208. Fastener 242(3) is secured to central shaft 206 and is thus biasing the central shaft 206 in the same direction. Note that while fastener 242(3) is identified as a distinct component, this fastener can also be viewed as a subcomponent of slide 240. In this example, the fastener 242(3) is externally threaded and is received by internal threads of slide 240 to allow length adjustment in the y direction of the slide 240/fastener 242(3) assembly.

The central shaft 206 extends through the clutch pack 208 and plate 244 and is secured relative to fastener 242(1). The bias on the fastener 242(1) is thus transferred to the plate 244 and then the clutch pack 208 by the plate. The opposite end of the clutch pack 208 is retained by bulkhead 246(2). Thus, the bias imparted by the plate 244 toward the bulkhead 246(2) compresses the clutch pack 208 and thereby creates increased resistance to rotation between individual clutch plates 214, 216, and 218. This increased resistance to rotation is configured to cause the device portions 102 and 104 to maintain this orientation unless acted upon by an external force (e.g., the user).

Note that in this configuration, while the first and second spring pairs 232(1) and 232(2) are sequentially arranged along the hinge shafts 204, the bias created by each spring pair 232 is transferred directly to the slide 240 and the central shaft 206 (e.g., the bias from second spring pair 232(2) is not imparted on first spring pair 232(1) and then to the central shaft through the first spring pair 232(1)). Thus, this configuration provides a technical solution so that despite the first and second spring pairs 232 being physically sequentially arranged along the hinge shafts 204, the first and second spring pairs functionally deliver their respective bias to the central shaft 206 as though they were organized in parallel (e.g., arranged side by side and directly in contact with the central shaft). This arrangement allows the first and second spring pairs to be sequentially arranged along the hinge shafts (e.g., in a relatively long and thin manner) yet perform as though they were arranged side by side (e.g., in a short and bulky manner).

Note further that while the springs 234 and 236 are positioned on the hinge shafts 204 the spring force (e.g., bias) generated by the springs is controlled by controller 220. In the relatively low frictional torque range from zero degrees to 15 degrees, the spring bias is transferred to the controller 220. In the relatively high frictional torque range from 15 degrees to 180 degrees, the spring bias can be transferred to the clutch pack 208. In the transition between high and low frictional torque the spring bias can be shared by the controller and the clutch pack. This solution provides a technical solution of eliminating skew or other issues that could result if the bias transferred down the hinge shafts was slightly unequal and thus would create more resistance to rotation around one hinge axis or the other. Instead, in this implementation controller 220 delivers a collective bias force to the clutch pack 208 that provides equal bias to the entire (e.g., each side) of the clutch pack.

In an instance where the user wants to close the device, such as from the 90-degree orientation, the user can exert a force on the first portion 102 and/or second portion 104 toward one another (e.g., in a closing direction) sufficient to overcome the resistance to rotation (e.g., frictional torque) created by the clutch pack 208. In such a case, the controller's surfaces 224 and 226 interact with the helical contact surfaces 228 and 230 of the rotation sleeves 222 to cause equal rotation of both the first and second portions. Note that the pitch of contact surfaces 228(1) and 228(2) as well as 230(1) and 230(2) are essentially equal to promote equal rotation around the two hinge shafts and to avoid binding. Stated another way, in order for either of the rotation sleeves 222 to be rotated around the hinge axes (e.g., hinge shafts 204) relative to the controller 220, the interaction of the controller's surfaces 224 and 226 with the helical contact surfaces 228 and 230 causes the controller 220 to move along the central shaft 206 in the y reference direction (e.g., parallel to the central shaft 206). This movement of the controller 220 in the y direction comes with associated interaction of its surfaces 224 and 226 with contact surfaces 228 and 230 of the other rotation sleeves 222 and forces simultaneous and equal rotation of each rotation sleeve 222 due to the helical shape of contact surfaces 228 and 230. In some configurations, the rotation can be exactly simultaneous and equal. Other configurations can allow a few degrees variation, such as up to +/−ten degrees associated with design tolerances and associated slack in the system. Either way, during this rotation, the frictional torque provided by the clutch pack 208 can remain relatively steady or at least relatively high compared to the relatively low state described below relative to FIGS. 4A and 4B.

FIGS. 3A and 3B collectively show the hinge assembly 106 after simultaneous and equal rotation of the first and second portions from the 180-degree orientation to a 15-degree orientation. The rotation of the first and second portions produces rotation of the rotation sleeves 222 and associated movement of the controller 220 toward the clutch pack 208 until the controller 220 contacts fastener 242(2). Contact with the fastener 242(2) blocks further movement of the controller 220 along the central shaft 206. In order for the controller 220 to move farther toward the clutch pack 208 (as the result of continued rotation of the first and second portions 102 and 104 toward one another) the controller moves the central shaft 206 with it. Moving the central shaft 206 will entail overcoming the bias created by the springs 234 and 236 on the central shaft toward the spring assembly 231. In this implementation, such movement of central shaft 206 starts at 15 degrees and continues to zero degrees. This central shaft movement is relatively small and may be difficult to perceive in the drawings. However, the movement has large effects on the function of the hinge assembly 106.

Three gaps (G) are shown in FIGS. 3B and 4B for comparison to aid the reader to appreciate the movement of the central shaft 206. The first gap G1 relates to the amount of space between fastener 242(1) and plate 244. The second gap G2 relates to the amount of space between slide 238 and slide 240 and reflects the extent of the compression of the first spring pair 232(1). The third gap G3 relates to the amount of space between slide 240 and bulkhead 246(3) and reflects the extent of the compression of the second spring pair 232(2). These gaps remain relatively steady in the high friction condition between the 180-degree orientation of FIGS. 2A-2D and the 15-degree orientation of FIGS. 3A and 3B. This 15-degree orientation represents changing or transition conditions that are distinguishable in the zero-degree orientation. Each of these gaps G expands from the 15-degree orientation of FIGS. 3A and 3B to the zero-degree orientation of FIGS. 4A and 4B.

FIGS. 4A and 4B show the hinge assembly 106 in the zero-degree orientation. At this point, the controller 220 has contacted fastener 242(2) and overcome the bias of the spring pairs 232 to move the central shaft 206 upwardly (e.g., in a direction opposite to the spring bias). This upward movement (e.g., in the +y direction) can be reflected in gap one G1₀ which is larger than G1₁₅ at the 15-degree orientation and shows that the compressive force on the clutch pack 208 that is created by the bias of the spring pairs 232 is decreased. Thus, the resistance to rotation (e.g., frictional torque) created by the clutch pack 208 is reduced. This allows the first and second portions to be rotated with less force than is required at orientations from 15 degrees and upwards. Stated another way, the reduced compressive force on the clutch pack provides a technical solution that allows the user to more easily open the device from the zero-degree (e.g., closed orientation) than would be required without reducing the compressive force on the clutch pack 208.

The upward movement of the central shaft 206 (e.g., away from the spring assembly 231) has also pulled slide 240 upwardly as represented by the increase in gap G2₀ (compared to G2₁₅) and gap G3₀ (compared to G3₁₅). The upward movement of slide 240 compresses first and second spring pairs 232 and thus stores potential energy in the spring pairs. This stored potential energy can subsequently be released as kinetic energy that automatically opens or pops-up the device from the closed orientation. For instance, the device could include a lock that can hold the device at the zero-degree orientation when the user closes it. When the user once again wants to open the device and unlocks the lock, the pop-up force can automatically force the first and second portions apart to the 15-degree orientation, where the potential energy is all converted to kinetic energy and the clutch pack 208 is once again compressed and increases the resistance to rotation (e.g., frictional torque) for continued opening to higher (e.g., greater than 15 degree) orientations.

The controller 220 operates in concert with the spring assembly 231, the rotation sleeves 222, the hinge shafts 204, the central shaft 206, and the clutch pack 208 to provide a technical solution of orientation specific frictional torque. Low angles (e.g., approaching and including closed) have low frictional torque so the user can easily move the first and second portions, such as with one hand. Higher angles, such as starting at 15 degrees and progressing to fully open provide increased frictional torque to hold the device in whatever orientation the user sets.

This hinge assembly 106 offers several advantages that have been introduced above. For instance, in the illustrated configuration the springs 234(1) and 236(1) are positioned around hinge shaft 204(1) and the springs 234(2) and 236(2) are positioned around hinge shaft 204(1). However, the spring bias is not transferred to the clutch pack 208 along the hinge shafts 204. Instead, the spring bias is selectively transferred to the central shaft 206 and imparted collectively to the center of the clutch pack 208 by plate 244 depending upon orientation. This configuration can provide a technical solution of obviating any differences in spring bias imparted by springs 234(1) and 236(1) compared to springs 234(2) and 236(2) that might cause canting and binding of the hinge assembly 106. Further, this configuration allows the full bias force of each spring pair to be imparted on the central shaft rather than the second spring pair applying its bias force to the first spring pair.

As introduced above, the hinge assembly 106 includes clutch pack 208 that functions as a clutch-pack style friction engine. The hinge assembly 106 also includes two or more spring pairs 232 for compressing the clutch pack 208 to generate frictional torque. Further, fastener 242(1) functions as an adjustment nut for tuning the magnitude of compressive force applied on the clutch pack 208 for adjustable frictional torque. Also, the timing shuttle 210 is manifest as a helical timing shuttle with a sliding component (e.g., controller 220) interacting with helical contact surfaces 228 and 230. The controller 220 provides a technical solution of engaging/disengaging the clutch pack 208 at a selected hinge open angle (e.g., 15 degrees in this implementation). The surfaces 228 and 230 of the rotation sleeves 222 are helical contact surfaces that have a constant and matching pitch. Engagement between the controller 220 and the helical contact surfaces 228 and 230 of the rotation sleeves 222 provides a technical solution that produces a rotational force applied to both the first and second portions producing linear movement of the controller and resultant equal rotation of both rotation sleeves 222 and hence both hinge arms 202 and thus each of the first and second portions 102 and 104. Stated another way, if the user attempts to decrease the orientation of the first portion, the user imparts a rotational force on rotation sleeve 222(1). This configuration provides a technical solution that in order for the rotation sleeve 222(1) to rotate, the controller 220 has to move along the central shaft 206. In order for the controller 220 to move along the central shaft 206, equal but opposite rotation has to occur on second rotation sleeve 222(2). Thus, the rotation imparted on the first portion causes equal and simultaneous rotation of both rotation sleeves 222 and hence both the first and second portions but in opposite directions. Thus, if the first portion rotates counter-clockwise, the second portion simultaneously rotates an equal amount clockwise. This produces a technical solution in that both portions stay timed (e.g., symmetric) with one another.

As mentioned above, in this case, the open angle for the pop-up force ranges from 0 degree to 15 degrees or 7.5 degrees per side. The timing shuttle 210 provides a technical solution of functioning as a controlling link mechanism between the clutch pack 208 and the spring assembly 231 (e.g., the spring pairs 232) to allow the clutch pack to remain in its relatively high friction state unless the controller 220 is in contact with fastener 242 and thereby decreases the compression of the clutch pack created by the spring bias. This controlling link mechanism also provides a technical solution of storing and transferring force from the spring pairs 232 to generate a pop-up force for automatically opening the device from the closed position.

This implementation includes adjustability of the hinge open angle (e.g., transition orientation) at which engagement/disengagement of the clutch pack 208 occurs. This adjustability is accomplished by turning fastener 242(2) on the central shaft 206 to select the angle at which the controller 220 engages the fastener 242(2) and hence effects the compression force imparted on the clutch pack 208 by the spring bias. The same fastener 242(2) determines the range of hinge open angles where a translational force is applied to the timing shuttle 210 (e.g., controller 220) for popping open the hinge assembly. Thus, the illustrated hinge assembly offers a clutch-pack style friction engine with tunable friction and pop-up angle. Further, the timing shuttle 210 controls the friction state of the clutch pack 208 according to orientation and causes pop up energy to be stored in the springs 234 and 236. This provides a technical solution by achieving multiple functionalities with a single timing shuttle 210 (e.g., the controller 220) rather than employing different structures to achieve each of these functions.

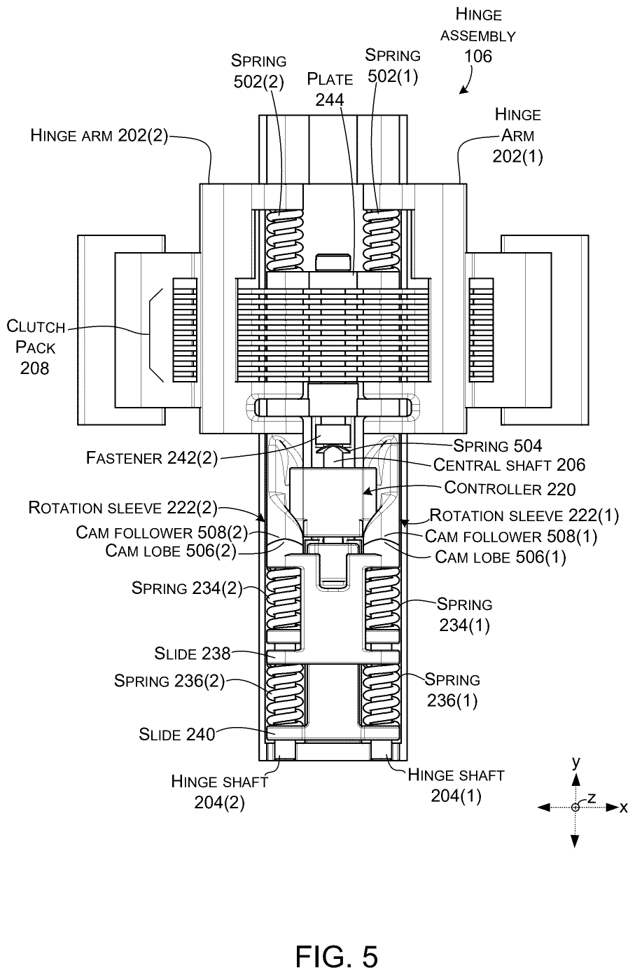

FIG. 5 shows another example hinge assembly 106 at the 180-degree orientation. This hinge assembly is similar to the hinge assembly of FIGS. 2A-4B so not all elements are re-introduced for sake of brevity. The hinge assembly offers several additional functionalities. The additional functionalities provide technical solutions relating to variable frictional torque, a smoother transition between the high and low frictional torque ranges, and maintaining a minimum frictional torque through the entire range of orientations. In this case, hinge assembly 106 includes springs 502, spring 504, cam lobes 506, and cam followers 508.

Springs 502 can be positioned on the hinge shafts 204 and captured between the hinge arms 202 and plate 244. These springs 502 are not subject to control by controller 220 and as such always apply linear force or bias on the clutch pack 208. In turn, the clutch pack 208 maintains frictional torque associated with the linear force from the springs 502. As such, springs 502 provide a technical solution of a constant frictional torque through the entire range of rotation in contrast to frictional torque associated with the springs 234 and 236, which is orientation dependent. Thus, springs 502 ensure that a minimal frictional torque is maintained for the first and second portions through the range of orientations.

Spring 504 can be positioned between fasteners 242(2) and controller 220 or at other locations. The controller 220 contacting the fastener 242(2) transitions the hinge assembly 106 from the relatively high frictional torque state to the relatively low frictional torque state. Inclusion of the spring 504 can smooth this transition. This smoother transition can create an enhanced and refined user experience. Specifically, when the controller 220 approaches the fastener 242(2) as the orientation approaches the transition orientation, the controller 220 squeezes the spring 504 between the controller and the fastener 242(2). The spring 504 temporally absorbs force as it is compressed. The spring 504 initially absorbs more force in its uncompressed state and then the amount of force absorbed decreases inversely as the spring 504 compresses. Once the spring 504 is fully compressed the force transfer proceeds as it would without the spring (e.g., the spring becomes uncompressible). Thus, the spring creates a rather smooth force transfer profile from high to low rather than a relatively bi-furcated transition. The spring 504 functions in a similar manner when the device is opened from a closed orientation to the transition orientation. The spring 504 can start to impart its stored spring force to compress the clutch pack slightly before the force from springs 234 and 236 are transferred to the clutch pack by the controller 220.

The smoother transition between frictional torque states created by spring 504 can decrease sudden shock or load on the hinge assembly 106 and thus can provide a technical solution of increasing the lifespan of the device through thousands of opening and closing cycles. The illustrated spring 504 is a spring washer. Other examples can include coil springs, Belleville washers, and/or wave washers, among others.

The cam lobes 506 can be defined by the slide 238 and the cam followers 508 can be defined by the rotation sleeves 222 (or vice versa). The cam lobes 506 and the cam followers 508 can be arranged around the hinge shafts 204 to create an axial cam function. The addition of the cam lobes 506 and the cam followers 508 functioning as an axial cam creates variable torque through a portion of the range of rotation and/or all of the range of rotation of the device. Stated another way, the variable torque can be achieved by controlling spring preload as a function of hinge position using the axial cam.

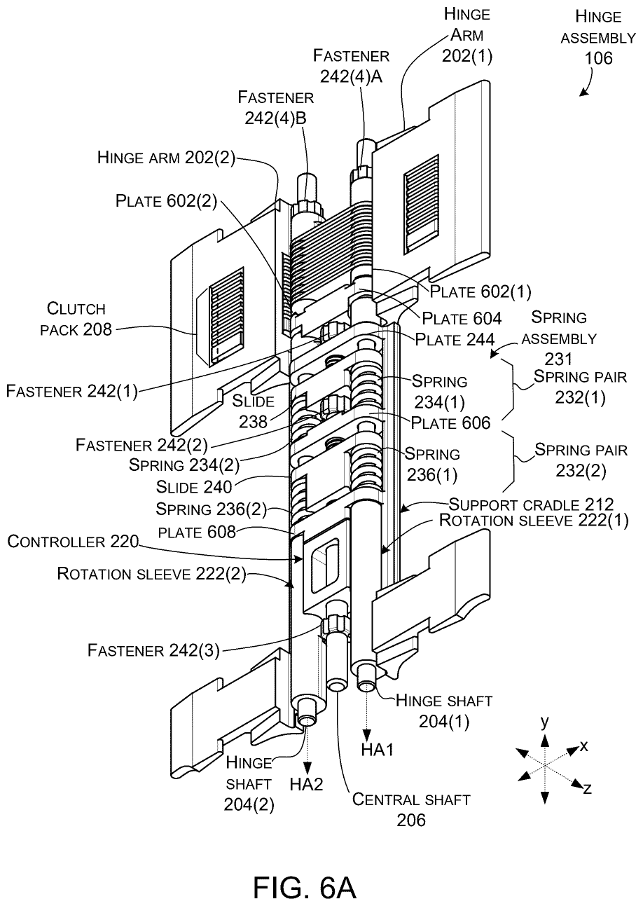

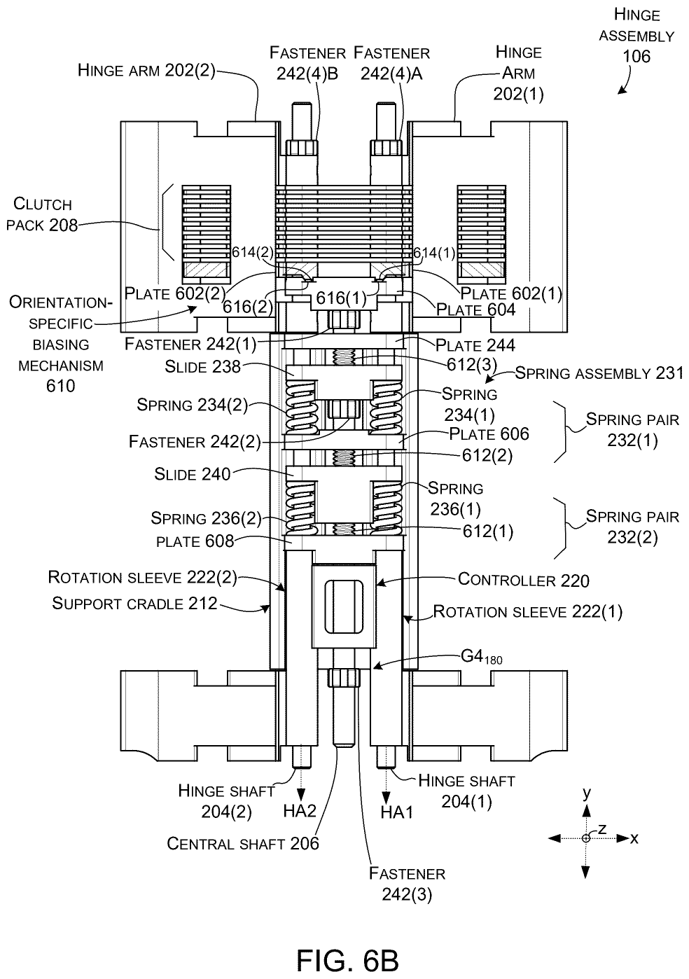

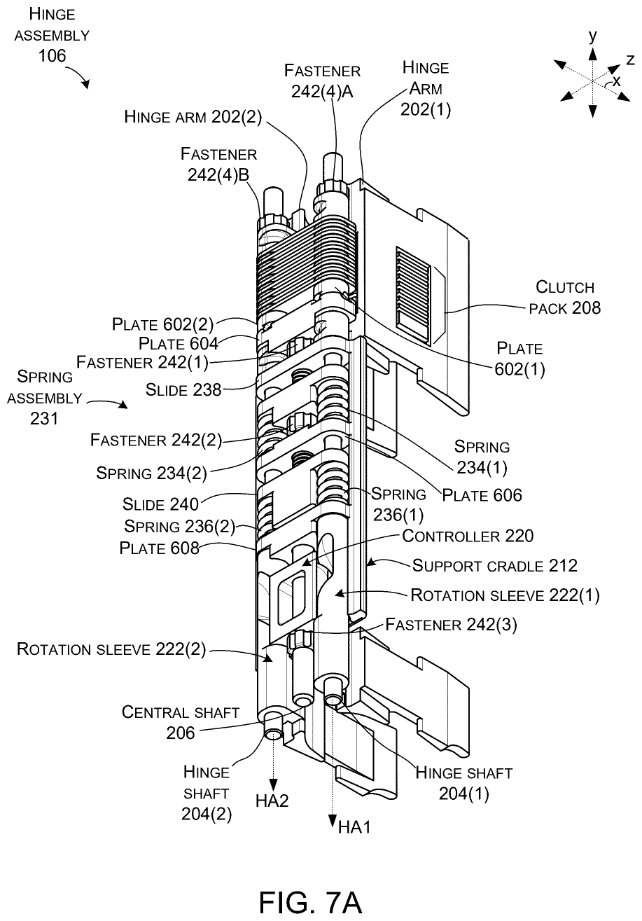

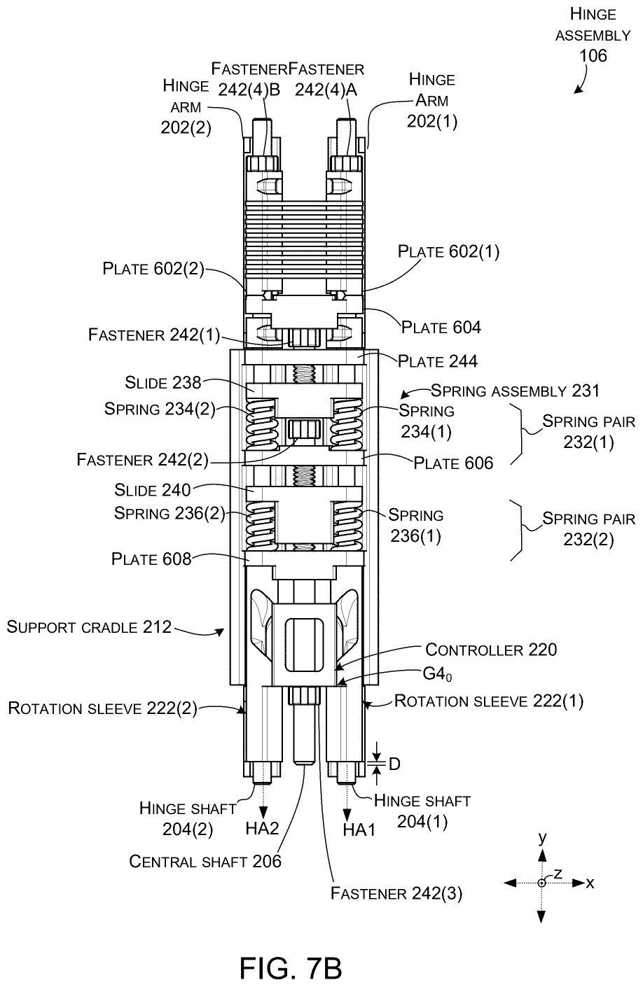

FIGS. 6A-7B collectively show another example hinge assembly 106. This implementation is similar to the implementation described above relative to FIGS. 2A-4B. As such, not all elements are re-introduced here for sake of brevity. This implementation adds additional fasteners 242(4)A and 242(4)B, plates 602, plate 604, plate 606, plate 608, and an orientation-specific biasing mechanism 610 (all labeled at least on FIG. 6B). Plates 244, 606, and 608 are fixed in place, whereas plate 604 and slides 238 and 240 can move with the central shaft 206.

In this implementation, all of the fasteners 242 are manifest as adjustable fasteners, such as threaded nuts which can be selectively positioned along threaded portions of the central shaft 206. Fasteners 242(4)A and 242(4)B provide adjustment between the hinge shafts 204(1) and 204(2) and the hinge arms 202(1) and 202(2), respectively. Fastener 242(1) provides adjustment between the central shaft 206 and plate 604. Fastener 242(2) provides adjustment between the central shaft 206 and slide 238 and fastener 242(3) provides adjustment between the central shaft 206 and the controller 220.

In this implementation, the central shaft 206 is manifest as three different sections 612 (FIG. 6B). A first section 612(1) extends through the controller 220, plate 608, and is threaded into slide 240. A second section 612(2) extends from slide 240 through plate 606 and is threaded through fastener 242(2) into slide 238. A third section 612(3) extends from slide 238 through plate 244 and is threaded through fastener 242(1) and into plate 604. This configuration allows individual sections to rotate relative to one another while maintaining continuity for transferring forces along the central shaft 206.

This implementation adds orientation-specific biasing mechanism 610. In this case, the orientation-specific biasing mechanism 610 creates a bias force to maintain the device at the 180-degree orientation. The orientation-specific biasing feature can be employed for other and/or additional orientations. For instance, the orientation-specific biasing feature could be employed at the 90-degree orientation and the 180-degree orientation, among others. In this implementation, the orientation-specific biasing feature is manifest as protuberances 614 (FIG. 6B) that are aligned with and extend into receptacles 616 (FIG. 6B) at the 180-degree orientation to form detents. Protuberance 614(1) is formed on plate 602(1) and protuberance 614(2) is formed on plate 602(2). Receptacles 616(1) and 616(2) are formed in plate 604.

In the 180-degree orientation, the protuberances 614 are positioned in the respective receptacles 616. The orientation-specific biasing mechanism 610 operates cooperatively with the clutch pack and the spring bias to maintain a particular orientation, which in this case is the 180-degree orientation. In order to rotate the first and second portions relative to the hinge assembly 106, the first and second portions have to be rotated with sufficient force to overcome the rotational torque generated by the clutch pack 208 and the spring bias and push the plate 604 away from the clutch pack 208 and back toward the spring assembly 231 and thus further compress the springs 234 and 236. From an energy perspective, alignment of the protuberances 614 with the receptacles 616 causes the hinge assembly to be at a lower energy state at the 180-degree orientation than at other orientations and thus the hinge assembly stays at this orientation lacking an external rotational energy input.

As orientation angle decreases from the 180-degree orientation, interaction of the controller 220 and the rotation sleeves 222 ensures that synchronous rotation occurs around each hinge shaft 204. This interaction is discussed above relative to FIGS. 2A-4B and involves engagement of the surfaces of the controller 220 with helical contact surfaces of the rotation sleeves 222. These surfaces are shown relative to FIGS. 6A-7B, but are not specifically designated to avoid clutter on the drawing page.

Once the protuberances 614 are rotated out of receptacles 616 at about the 170-degree orientation, the hinge assembly continues to operate in a generally steady state of relatively high frictional torque until reaching a transition orientation of about 15 degrees. During this relatively high frictional torque range, the springs 234 and 236 are imparting a biasing force on the clutch pack 208 and the clutch pack creates frictional torque to maintain the device at orientations in this range unless acted upon by the user (e.g., with a greater rotational force).

In this implementation, the transition orientation is established by adjusting the position of fastener 242(3) (e.g., threaded adjustable nut) along the central shaft 206. The transition from relatively high frictional torque to relatively low frictional torque begins when controller 220 contacts fastener 242(3). This contact can move the central shaft 206 and plate 604 slightly away from the clutch pack 208 to reduce frictional torque generated by the clutch pack 208. The movement of the central shaft 206 can also cause one or both of the first and second spring pairs to be compressed to store pop-up energy (e.g., the controller can control the first and second spring pairs independently). In the illustrated configuration, only spring pair 232(2) is compressed to store pop-up energy. These aspects are shown in the zero-degree orientation of FIGS. 7A and 7B and can be visualized by comparing FIGS. 7A and 7B to the 180-degree orientation of FIGS. 6A and 6B. For instance, gap G4₁₈₀ in FIG. 6B shows the gap between the controller 220 and the fastener 242(3). In the zero-degree orientation of FIG. 7B, the central shaft 206 has moved downward until the controller 220 is in contact with the fastener 242(3) (e.g., gap G4₀ is zero). Once the controller 220 contacts fastener 242(3), at the transition orientation, further downward movement of the controller (e.g., from the transition orientation to the zero orientation) causes downward movement of the central shaft 206 as identified as displacement D in FIG. 7B.

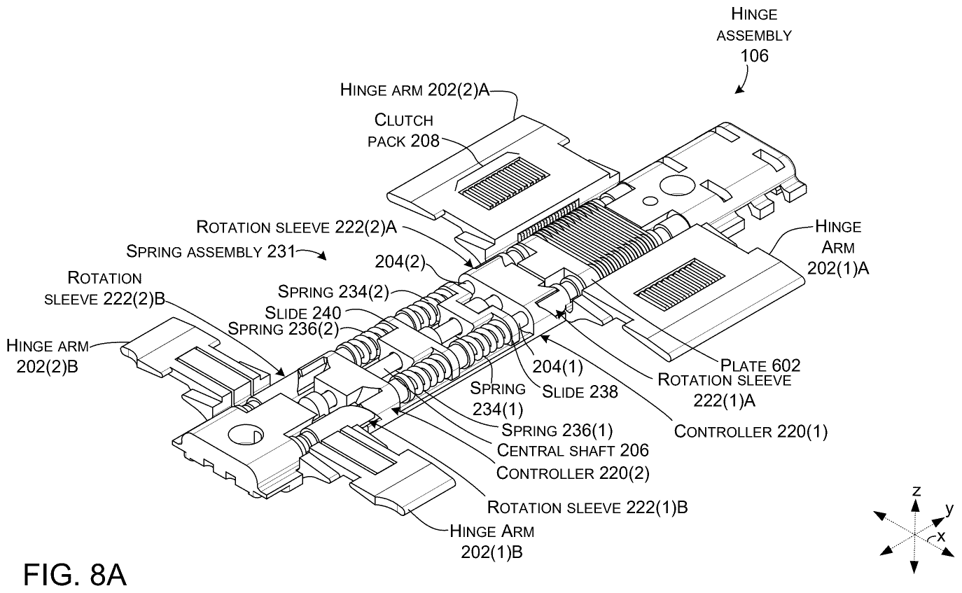

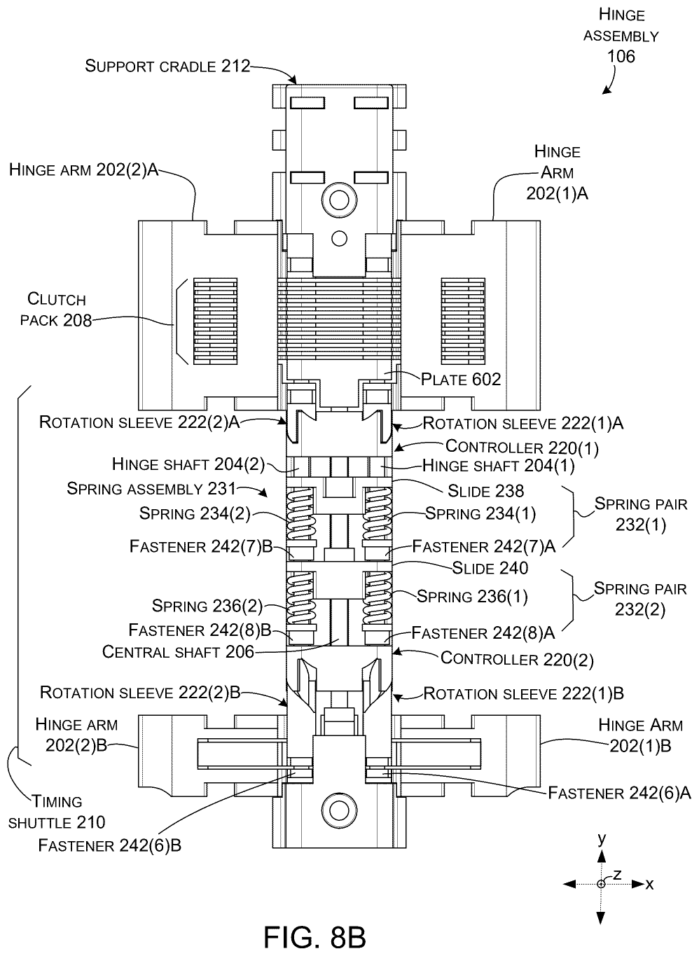

FIGS. 8A and 8B shows another example hinge assembly 106 at the 180-degree orientation. This hinge assembly 106 shares many of the elements introduced relative to the hinge assemblies described above and as such not all of the elements are reintroduced here for sake of brevity. Of note, this implementation splits the timing shuttle 210 (e.g., the rotation sleeves 222 and the controller 220) transverse to the central shaft 206. Similarly, the hinge arms are split into upper hinge arms 202(1)A and 202(2)A and lower hinge arms 202(1)B and 202(2)B. The upper hinge arms 202(1)A and 202(2)A are associated with upper rotation sleeves 222(1)A and 222(2)A and the lower hinge arms 202(1)B and 202(2)B are associated with lower rotation sleeves 222(1)B and 222(2)B. This configuration creates upper rotation sleeves 222(1)A and 222(2)A that engage upper controller 220(1). Lower rotation sleeves 222(1)B and 222(2)B engage lower controller 220(2). The first and second spring pairs 232 are positioned between the upper controller 220(1) and the lower controller 220(2). In this configuration the timing surfaces (e.g., helical contact surfaces (228 and 230 (labelled, FIG. 2C)) of the rotation sleeves are adjustable (e.g., the distance between the upper and lower rotation sleeves can be adjusted, which in turn adjusts the distances between the upper rotation sleeves and the upper controller and the lower controller and the lower rotation sleeves). In this case, the adjustment is achieved with fasteners 242(6)A and 242(6)B. The position of these fasteners can be preliminarily set during assembly and the position can be adjusted after assembly. In the case of threaded fasteners, final adjustment entails rotating the fasteners until the desired adjustment is achieved. In other cases, the fasteners can be adjusted and then welded or otherwise secured in place. This adjustment allows the gap between elements of the timing shuttle 210 to be reduced to a slip fit during assembly and then fine-tuning adjustment can be performed as part of tolerance checking.

This timing shuttle 210 is larger in length (as measured along the hinge axes) and width (as measured across the hinge axes) than other implementations. The larger length and/or width reduces backlash effect on the timing shuttle clocking about the z axis. The timing shuttle rides on the two hinge shafts 204 and rails defined by the support cradle 212 rather than on the central shaft 206 and a single rail. This configuration prevents deflection about the y axis as shown in some helical timing systems.

In this implementation, fasteners 242(7) (FIG. 8B) function as spring retention features for springs 234 to capture these springs between slide 238 and fasteners 242(7). Similarly, fasteners 242(8) (FIG. 8B) function as spring retention features for springs 236 to capture these springs between slide 240 and fasteners 242(8). The fasteners 242(7) and 242(8) can be threaded fasteners that allow adjustment in the y reference direction along the hinge shafts 204.

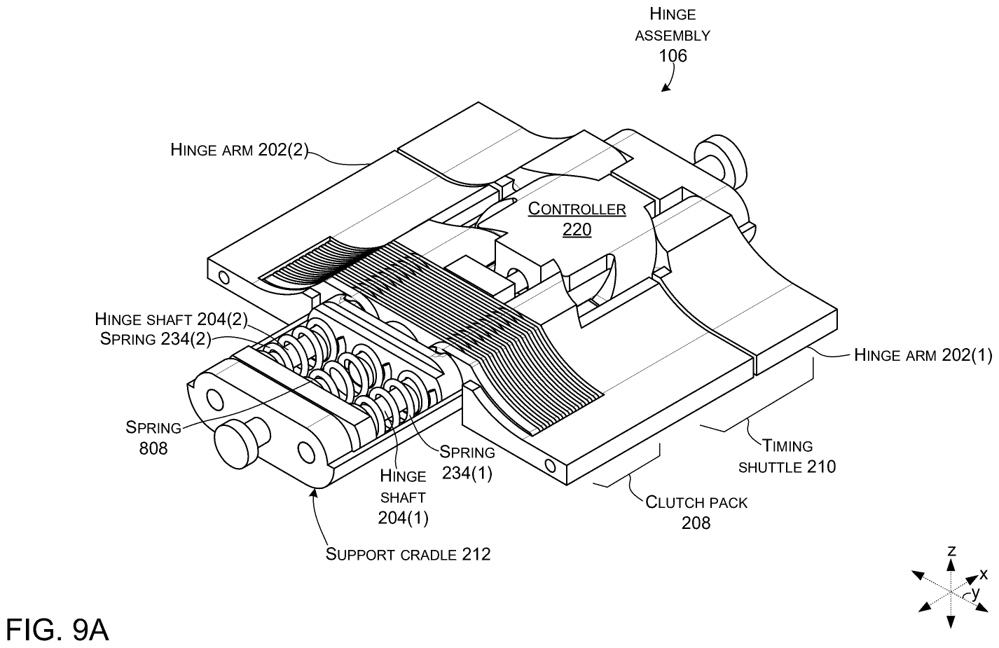

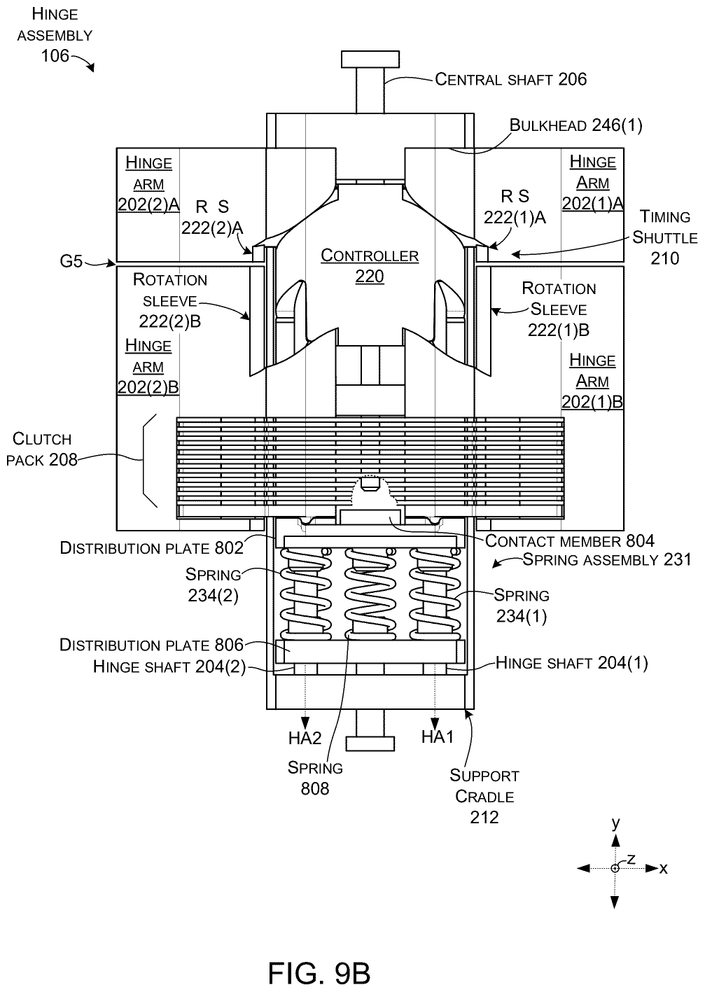

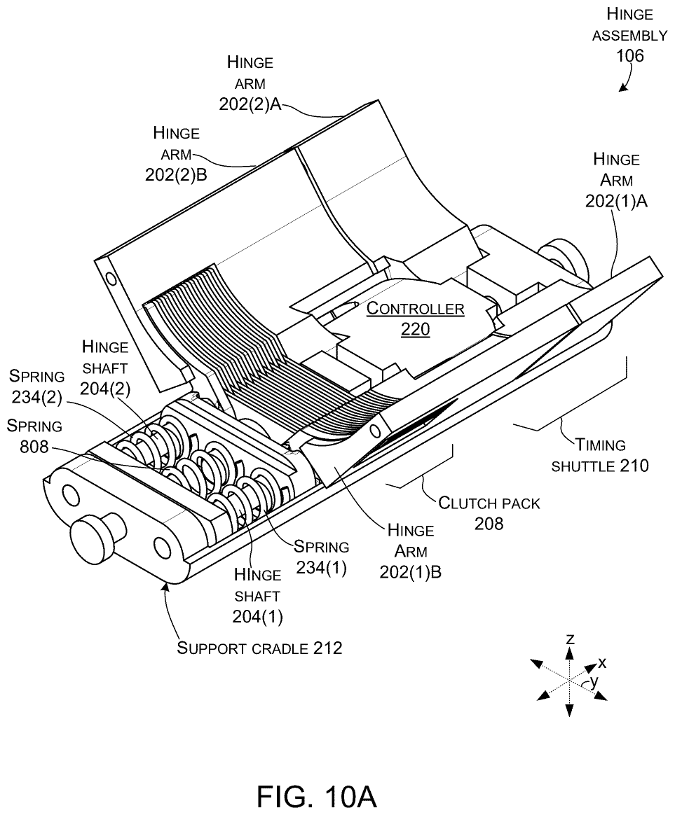

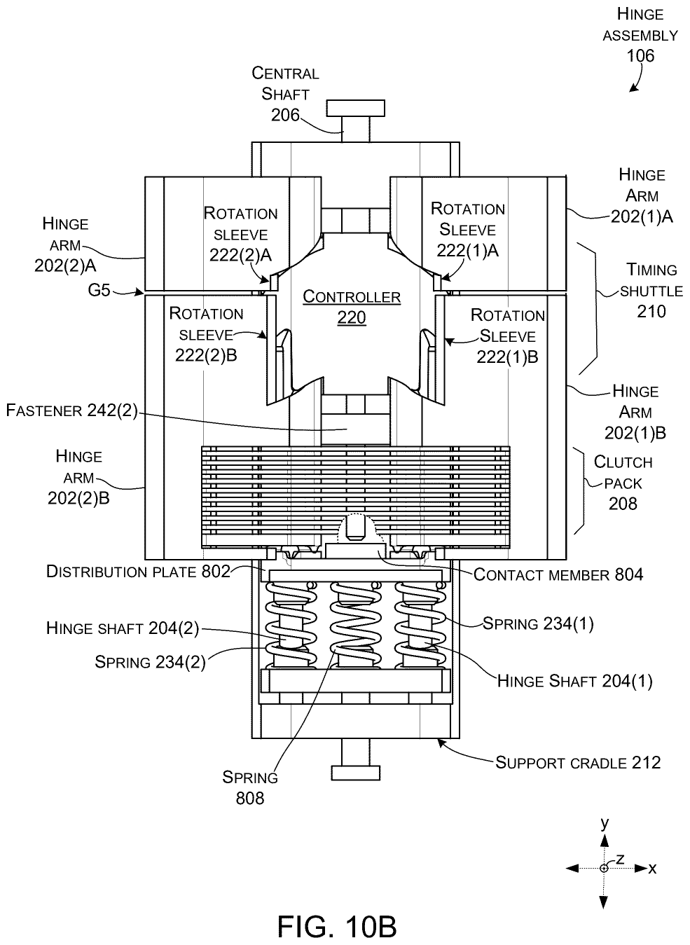

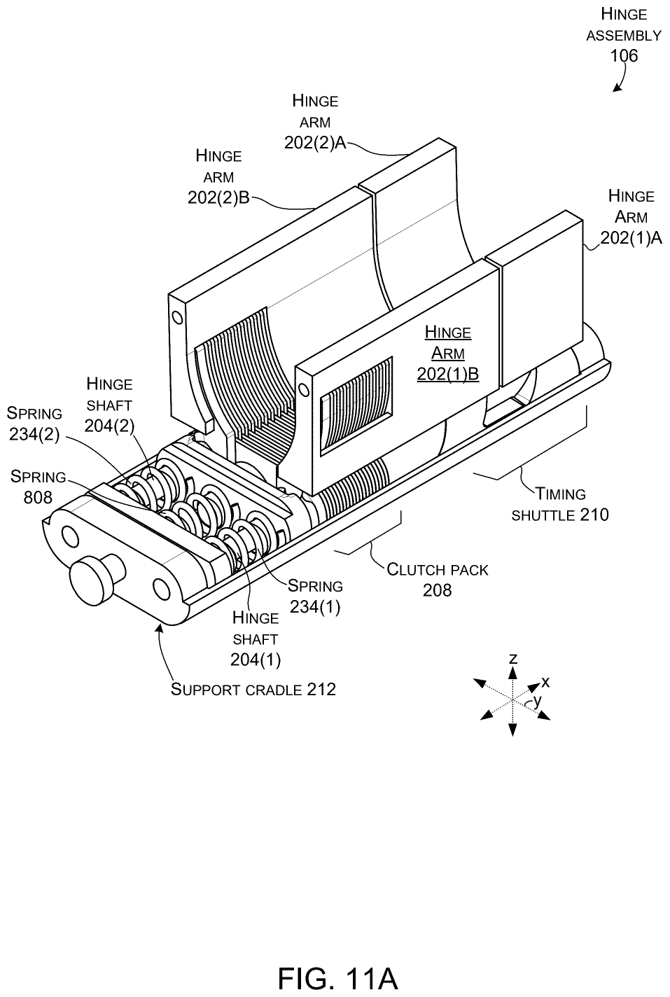

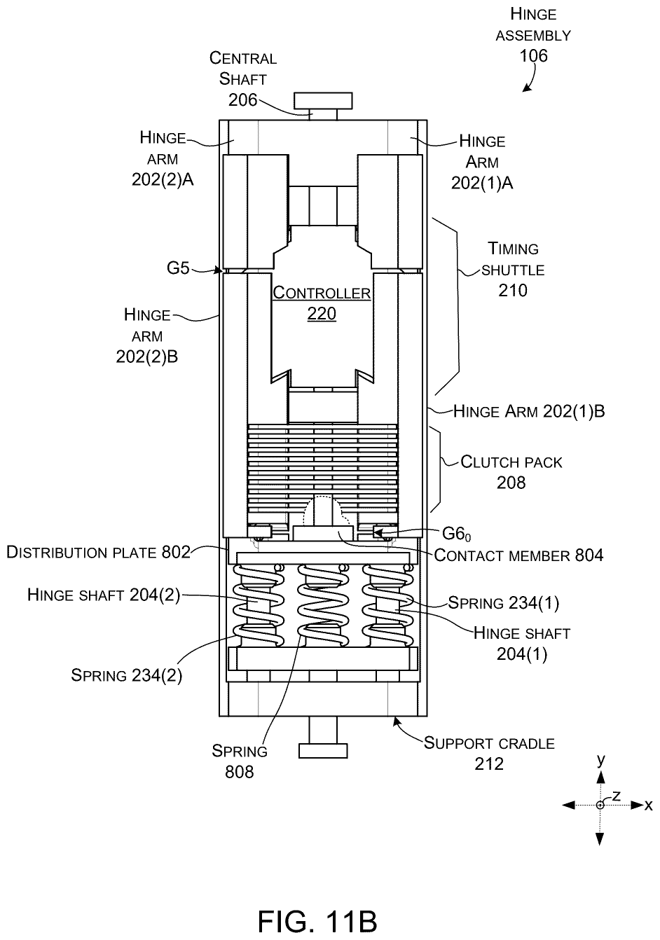

FIGS. 9A-11B shows another example hinge assembly 106. FIGS. 9A and 9B show the hinge assembly at the 180-degree orientation, FIGS. 10A and 10B show the hinge assembly at the 15-degree orientation, and FIGS. 11A and 11B show the hinge assembly at the zero-degree orientation. Note that each of FIGS. 9B, 10B, and 11B include a partial cutaway of the clutch pack 208 to reveal the end of the central shaft 206. This purpose of this visualization will become apparent below.

This example hinge assembly 106 includes distribution plate 802, contact member 804, distribution plate 806, and spring 808. In this configuration, spring 808 is positioned co-extensive with the central shaft 206 between springs 234(1) and 234(2), which are positioned on the hinge shafts 204(1) and 204(2), respectively. Spring 234(1), spring 808, and spring 234(2) are captured between distribution plate 802 and distribution plate 806.

In this implementation the hinge arms 202 are split at the controller 220 in the xz reference plane (e.g., transverse to the central shaft 206) into upper hinge arms 202(1)A and 202(2)A and lower hinge arms 202(1)B and 202(2)B. This is evidenced by a slight gap G5 that is intentionally created between the upper and lower hinge arms. The gap G5 on the split hinge arms of this arrangement provides flexibility for adjustment to reduce clearance to the controller 220 in order to reduce/minimize backlash in the timing shuttle 210. From one perspective, the gap G5 allows (or is representative of) upper hinge arms 202(1)A and 202(2)A and lower hinge arms 202(1)B and 202(2)B not being fixed together in the Y direction, but they are fixed in every other direction/rotation. Thus, the gap G5 represents that the lower hinge arms 202(1)B and 202(2)B have at least a tiny bit of freedom in the y reference direction so that it can squeeze out any gaps between the rotation sleeves 222 and the controller 220. This configuration provides a technical solution that reduces play and/or backlash and thus enhancing the degree of synchronization of the first and second hinge arms 202 and hence the first and second portions relative to one another. In this case, the controller's surfaces are captured between the contact surfaces defined by upper rotation sleeves 222(1)A and 222(2)A and the contact surfaces defined by the lower rotation sleeves 222(1)B and 222(2)B. The controller's surfaces 224 and 226 and contact surfaces 228 and 230 are shown but not labelled here and are labelled above relative to FIG. 2D.

In the example illustrated configuration, the upper hinge arms 202(1)A and 202(2)A are justified in the y reference direction against the upper bulkhead 246(1). The controller 220 is justified in the y reference direction against the upper hinge arms 202(1)A and 202(2)A. The lower hinge arms 202(1)B and 202(2)B are justified in the y reference direction against the controller 220. All of this justification is driven by the spring load through the distribution plate 802 and clutch pack 208 (e.g., the timing components are sandwiched under pressure (e.g., force) between the distribution plate 802 and the bulkhead 246(1). Other implementations could re-order the components as long as the hinge arms 202 squeeze on the controller 220 in the y reference direction.

FIGS. 9A and 9B show the hinge assembly 106 in a 180-degree orientation that is representative of relatively high frictional torque state. At this orientation, the spring 234(1), spring 808, and spring 234(2) are imparting a bias on distribution plate 802. The distribution plate 802 conveys the bias to the clutch pack 208. The clutch pack 208 is captured between distribution plate 802 and lower hinge arms 202(1)B and 202(2)B. Thus, the bias from spring 234(1), spring 808, and spring 234(2) compresses the clutch pack 208 together and the clutch pack creates a relatively high frictional torque on the first and second portions.

FIGS. 10A and 10B show the hinge assembly 106 in the 90-degree orientation. Spring 234(1), spring 808, and spring 234(2) continue to impart a biasing force on the clutch pack 208 (e.g., the clutch pack 208 continues to be compressed). In turn, the clutch pack 208 maintains the hinge assembly 106 in the relatively high frictional torque state. Note however, that when compared to the 180-degree orientation of FIGS. 9A and 9B, as the controller 220 has traveled toward spring 234(1), spring 808, and spring 234(2) as part of its synchronizing function (e.g., interacting with rotation sleeves 222), the controller has moved the central shaft 206 toward the contact member 804. No contact is occurring between the central shaft 206 and the contact member 804, but the subsequent contact represents the transition from the relatively high frictional torque state to a relatively lower frictional torque state.

FIGS. 11A and 11B show the hinge assembly 106 in the zero-degree orientation in a relatively lower frictional torque state. The controller's interaction with the rotation sleeves 222 associated with rotation of the first and second portions, has moved the controller 220 towards the clutch pack 208. The controller 220 moved the central shaft 206 with it. At the transition orientation, which is not shown relative to this implementation but can occur at an orientation in a range of 5 to 30 degrees, for example, the central shaft 206 contacted the contact member 804. The continued movement of the controller 220 and the central shaft 206 moved the contact member 804 downward (e.g., away from the clutch pack 208). The contact member 804 overcame the bias created by the springs 234 and 808 and forced the distribution plate 802 away from the clutch pack 208. Removal of the spring bias from the clutch pack 208 decreases friction between the clutch plates of the clutch pack and hence decreases the frictional torque created by the clutch pack. Further, the movement of the distribution plate 802, away from the clutch pack 208 is compressing the springs 234 and 808, which are storing potential energy (e.g., pop-up energy). This movement of the distribution plate is indicated as gap G6₀ at the zero-degree orientation, whereas no corresponding gap exists at the 90-degree and 180-degree orientations. As described above, the pop-up energy can be released to automatically open the device.

This hinge assembly 106 allows three springs to be used side-by-side in the x reference direction. For a desired spring bias this configuration provides a technical solution that is more compact in the y (axial) direction. With the springs 234 and 808 external to the timing shuttle 210, additional space is not required around the springs to account for timing shuttle translation.

This hinge assembly configuration also provides a technical solution by addressing timing backlash by using the clutch pack spring load on the contact surfaces of the rotation sleeves 222 (double helix timing interfaces) in series with the clutch pack 208. The spring load takes out any backlash due to manufacturing variation. This is true over the entire range of motion of the hinge assembly.

Various example hinge assemblies are described that employ a central timing module to control the frictional state of the device, store pop-up energy, and synchronize rotation of the device.

Individual device elements can be made from various materials, such as metals, plastics, and/or composites. These materials can be prepared in various ways, such as from formed sheet metals, die cast metals, machined metals, 3D printed materials, molded or 3D printed plastics, and/or molded or 3D printed composites, among others, and/or any combination of these materials and/or preparations can be employed.

The present hinge assembly concepts can be utilized with any type of device, such as but not limited to notebook computers, smart phones, wearable smart devices, tablets, and/or other types of existing, developing, and/or yet to be developed devices.

Various methods of manufacture, assembly, and/or use for hinge assemblies and devices are contemplated beyond those shown above relative to FIGS. 1A-11B.

Although techniques, methods, devices, systems, etc., pertaining to hinge assemblies are described in language specific to structural features and/or methodological acts, it is to be understood that the subject matter defined in the appended claims is not limited to the specific features or acts described. Rather, the specific features and acts are disclosed as example forms of implementing the claimed methods, devices, systems, etc.

Various examples are described above. Additional examples are described below. One example includes a device comprising a first portion secured to a first hinge arm that is configured to rotate relative to a first hinge axis and a second portion secured to a second hinge arm that is configured to rotate relative to a second hinge axis, a clutch pack spanning the first hinge axis and the second hinge axis, a first rotation sleeve positioned around the first hinge axis, the first rotation sleeve defining first curved contact surfaces and a second rotation sleeve positioned around the second hinge axis, the second rotation sleeve defining second curved contact surfaces, and a controller positioned on a central shaft that is positioned between the first and second hinge axes, the controller configured to engage the first and second curved contact surfaces to synchronize rotation of the first and second rotation sleeves and to control a relative amount of resistance to rotation imparted on the first and second hinge arms by the clutch pack.

Another example can include any of the above and/or below examples where the device further comprises a first display positioned on the first portion and a second display positioned on the second portion, or further comprising a single display that extends across both the first portion and the second portion.

Another example can include any of the above and/or below examples where the device further comprises a first hinge shaft that is coextensive with the first hinge axis and a second hinge shaft that is coextensive with the second hinge axis and wherein the clutch pack comprises multiple clutch plates and wherein the controller is configured to control a relative amount of resistance to rotation imparted on the first and second hinge arms by the clutch pack by effecting an amount of bias imparted on the multiple clutch plates toward one another

Another example can include any of the above and/or below examples where the bias is imparted by the controller on the multiple clutch plates through the central shaft.

Another example can include any of the above and/or below examples where the bias is generated by springs that are co-extensive with the first and second hinge axes.

Another example can include any of the above and/or below examples where the bias is generated by the springs and another spring positioned on the central shaft.

Another example can include any of the above and/or below examples where the controller is configured to engage the curved first and second contact surfaces and travel parallel to the central shaft when a rotation force is imparted on either or both of the first and second portions.

Another example can include any of the above and/or below examples where the engagement of the controller with the first and second curved contact surfaces causes substantially equal and simultaneous rotation of the first portion and the second portion.

Another example can include any of the above and/or below examples where the curved first and second contact surfaces are helically curved.

Another example can include any of the above and/or below examples where the device further comprises springs that are configured to generate the bias.

Another example can include any of the above and/or below examples where the springs comprise a first spring pair that includes a spring on a first hinge shaft and a spring on a second hinge shaft, or wherein the springs further include a second spring pair that includes another spring on the first hinge shaft and another spring on the second hinge shaft, or wherein the springs further include a second spring pair that includes another spring on the first hinge shaft and another spring on the second hinge shaft and at least a third spring pair that includes additional springs on the first hinge shaft and the second hinge shaft.

Another example can include any of the above and/or below examples where the bias generated by the second spring pair is imparted directly on the controller and not through the first spring pair, or wherein the controller is configured to control the bias imparted by the first and second spring pairs independently.

Another example can include any of the above and/or below examples where the controller can cause the springs to be compressed as the first and second portions are closed together to create a pop-up force for opening the first and second portions.

Another example can include any of the above and/or below examples where the controller is configured to cause either of the first spring pair or the second spring pair to be compressed to create the pop-up force without compressing the other of the first spring pair or the second spring pair.

Another example can include any of the above and/or below examples where the controller is configured to cause the pop-up force to begin to be stored at a same orientation of the first and second portions that the controller begins to reduce the relative amount of resistance to rotation imparted on the first and second hinge arms by the clutch pack.

Another example can include a device comprising a first portion including a first display and a second portion including a second display and a hinge assembly defining a first hinge arm that is configured to rotate around a first hinge axis and a second hinge arm that is configured to rotate around a second hinge axis, the first hinge arm extending between the first hinge axis and the first portion and the second hinge arm extending between the second hinge axis and the second portion and a clutch pack that spans the first and second hinge axes, the hinge assembly further defining a controller configured to cause the clutch pack to impart a relatively high resistance to rotation on the first and second portions at a first orientation and to reduce the relatively high resistance to a relatively lower resistance at a second orientation.

Another example can include any of the above and/or below examples where the controller is further configured to selectively transfer a bias force to the clutch pack along a central shaft that is positioned between the first and second axes.

Another example can include any of the above and/or below examples where the first hinge arm is moveably secured to the first portion and the second hinge arm is moveably secured to the second portion, or wherein the first hinge arm is fixedly secured to the first portion and the second hinge arm is fixedly secured to the second portion.

Another example can include any of the above and/or below examples where the hinge assembly further comprises an orientation-specific biasing mechanism that is configured to operate cooperatively with the clutch pack to maintain the first and second portions in a particular orientation.

Another example can include any of the above and/or below examples where the orientation-specific biasing mechanism comprises a detent that is at least partially defined by the first and second hinge arms.

Another example can include any of the above and/or below examples where motion of the controller parallel to the first and second hinge axes is configured to simultaneously load the clutch pack to impart relatively high resistance to rotation and to end pop-up torque imparted on the first and second hinge arms.

Another example can include any of the above and/or below examples where the first hinge arm comprises split upper and lower first hinge arms and the second hinge arm comprises split upper and lower second hinge arms, and further comprising springs that are configured to bias the upper and lower first and second hinge arms toward one another.

Another example can include any of the above and/or below examples where the clutch pack is positioned between the split upper and lower first and second hinge arms.

Another example can include a device comprising a first portion secured to a first hinge arm that is configured to rotate around a first hinge axis and a second portion secured to a second hinge arm that is configured to rotate around a second hinge axis and a timing shuttle positioned on a central shaft that is located between the first hinge axis and the second hinge axis and is configured to control a frictional torque experienced by the first and second hinge arms depending upon orientation of the first and second hinge arms and to synchronize rotation of the first and second hinge arms around the first and second hinge axes.

Another example can include any of the above and/or below examples where the timing shuttle is further configured to cause potential energy to be stored when the orientation of the first and second hinge arms approaches a closed orientation.

Another example can include any of the above and/or below examples where the timing shuttle is further configured to cause potential energy to be stored when the orientation of the first and second hinge arms reaches 15 degrees and progresses toward the closed orientation.

Another example can include any of the above and/or below examples where the timing shuttle is further configured to decrease the frictional torque at 15 degrees to zero degrees.

1. A device, comprising:
a first portion secured to a first hinge arm that is configured to rotate relative to a first hinge axis and a second portion secured to a second hinge arm that is configured to rotate relative to a second hinge axis;
a clutch pack spanning the first hinge axis and the second hinge axis;
a first rotation sleeve positioned around the first hinge axis, the first rotation sleeve defining first curved contact surfaces and a second rotation sleeve positioned around the second hinge axis, the second rotation sleeve defining second curved contact surfaces; and,
a controller positioned on a central shaft that is positioned between the first and second hinge axes, the controller configured to engage the first and second curved contact surfaces to synchronize rotation of the first and second rotation sleeves and to control a relative amount of resistance to rotation imparted on the first and second hinge arms by the clutch pack.

2. The device of claim 1, further comprising a first display positioned on the first portion and a second display positioned on the second portion, or further comprising a single display that extends across both the first portion and the second portion.

3. The device of claim 1, further comprising a first hinge shaft that is coextensive with the first hinge axis and a second hinge shaft that is coextensive with the second hinge shaft and wherein the clutch pack comprises multiple clutch plates and wherein the controller is configured to control a relative amount of resistance to rotation imparted on the first and second hinge arms by the clutch pack by effecting an amount of bias imparted on the multiple clutch plates toward one another

4. The device of claim 3, wherein the bias is imparted by the controller on the multiple clutch plates through the central shaft.

5. The device of claim 4, wherein the bias is generated by springs that are co-extensive with the first and second hinge axes.

6. The device of claim 5, wherein the bias is generated by the springs and another spring positioned on the central shaft.

7. The device of claim 5, wherein the controller is configured to engage the curved first and second contact surfaces and travel parallel to the central shaft when a rotation force is imparted on either or both of the first and second portions.

8. The device of claim 6, wherein the engagement of the controller with the first and second curved contact surfaces causes substantially equal and simultaneous rotation of the first portion and the second portion.

9. The device of claim 7, wherein the curved first and second contact surfaces are helically curved.

10. The device of claim 3, further comprising springs that are configured to generate the bias.

11. The device of claim 10, wherein the springs comprise a first spring pair that includes a spring on a first hinge shaft and a spring on a second hinge shaft, or wherein the springs further include a second spring pair that includes another spring on the first hinge shaft and another spring on the second hinge shaft, or wherein the springs further include a second spring pair that includes another spring on the first hinge shaft and another spring on the second hinge shaft and at least a third spring pair that includes additional springs on the first hinge shaft and the second hinge shaft.

12. The device of claim 11, wherein the bias generated by the second spring pair is imparted directly on the controller and not through the first spring pair, or wherein the controller is configured to control the bias imparted by the first and second spring pairs independently.

13. The device of claim 12, wherein the controller can cause the springs to be compressed as the first and second portions are closed together to create a pop-up force for opening the first and second portions.

14. The device of claim 13, wherein the controller is configured to cause either of the first spring pair or the second spring pair to be compressed to create the pop-up force without compressing the other of the first spring pair or the second spring pair.

15. The device of claim 14, wherein the controller is configured to cause the pop-up force to begin to be stored at a same orientation of the first and second portions that the controller begins to reduce the relative amount of resistance to rotation imparted on the first and second hinge arms by the clutch pack.

16. A device, comprising:
a first portion including a first display and a second portion including a second display; and,
a hinge assembly defining a first hinge arm that is configured to rotate around a first hinge axis and a second hinge arm that is configured to rotate around a second hinge axis, the first hinge arm extending between the first hinge axis and the first portion and the second hinge arm extending between the second hinge axis and the second portion and a clutch pack that spans the first and second hinge axes, the hinge assembly further defining a controller configured to cause the clutch pack to impart a relatively high resistance to rotation on the first and second portions at a first orientation and to reduce the relatively high resistance to a relatively lower resistance at a second orientation.

17. The device of claim 16, wherein the controller is further configured to selectively transfer a bias force to the clutch pack along a central shaft that is positioned between the first and second axes

18. The device of claim 17, wherein the first hinge arm is moveably secured to the first portion and the second hinge arm is moveably secured to the second portion, or wherein the first hinge arm is fixedly secured to the first portion and the second hinge arm is fixedly secured to the second portion.

19. The device of claim 17, wherein the hinge assembly further comprises an orientation-specific biasing mechanism that is configured to operate cooperatively with the clutch pack to maintain the first and second portions in a particular orientation.

20. A device, comprising:
a first portion secured to a first hinge arm that is configured to rotate around a first hinge axis and a second portion secured to a second hinge arm that is configured to rotate around a second hinge axis; and,
a timing shuttle positioned on a central shaft that is located between the first hinge axis and the second hinge axis and is configured to control a frictional torque experienced by the first and second hinge arms depending upon orientation of the first and second hinge arms and to synchronize rotation of the first and second hinge arms around the first and second hinge axes.
